(19) United States
(12) Patent Application Publication
(10) Pub. No.: US 2015/0066854 A1
(43) Pub. Date: Mar. 5, 2015

(54) DATA PROCESSING APPARATUS AND ITS CONTROL METHOD AND PROGRAM

(71) Applicant: CANON KABUSHIKI KAISHA, Tokyo (JP)

(72) Inventor: Takaaki Yokoi, Kawasaki-shi (JP)

(21) Appl. No.: 14/459,406

(22) Filed: Aug. 14, 2014

(30) Foreign Application Priority Data
Aug. 29, 2013 (JP) 2013-178320

(51) Int. Cl. G06F 17/30

(52) U.S. Cl. CPC G06F 17/30174; G06F 17/3028
USPC 707/634

(57) ABSTRACT

A data processing apparatus has: a generation unit for generating a sync signal related to a frame period of moving image data; a plurality of processing units each for executing a processing in accordance with the sync signal; a memory; and a memory control unit for accepting access requests to the memory from the plurality of processing units and control a data transfer between each of the plurality of processing units and the memory in accordance with the access request. The memory control unit sets a first period to mask the access request from a predetermined processing unit among the plurality of processing units in accordance with the sync signal and does not accept the access request from the predetermined processing unit in the first period.

### BACKGROUND OF THE INVENTION

1. Field of the Invention

The present invention relates to a data processing apparatus and, more particularly, to a data processing apparatus having a memory access control structure for controlling accesses to a shared memory from a plurality of masters which execute a data processing.

2. Description of the Related Art

In recent years, in imaging apparatuses such as digital still camera, video camera, and the like, a volatile memory is used as a temporary recording unit for storing a processing program which is executed by a CPU (Central Processing Unit), intermediate image data generated by an image processing unit, and the like. As a volatile memory, for example, there is an SDRAM (Synchronous Dynamic Access Memory). To such a shared memory which is accessed from a plurality of masters such as CPU, image processing unit, and the like, it is necessary to make an arbitration of a memory bus by a memory controller.

As a method of arbitrating access requests, there are a fixed priority method and a round robin method. In the fixed priority method, the access request from a bus master having a high priority is preferentially accepted in accordance with priorities which are predetermined to a plurality of masters. In the round robin method, the fixed priority of the bus master whose access request is accepted is lowered down to the lowest rank so that the access request from each master can be accepted equally.

Subsequently, a processing period of an imaging apparatus including an image processing apparatus will be described. The imaging apparatus includes: processings which are executed at a vertical period corresponding to a period of one frame of a moving image signal; and processings which are executed at a horizontal period corresponding to a period of one horizontal line of each frame of the moving image signal. Most of the processings of the imaging apparatus are executed at the vertical period. If those processings are completed within the vertical period, a system will not fail. As for the processings which are executed at the vertical period, a time-dependent allowance which is provided up to completion of each processing is larger as compared with that for each processing which is executed at the horizontal period. The processing at the vertical period is called “nonreal time processing” hereinbelow. A part of the processings of the imaging apparatus are executed at the horizontal period. Also with respect to the processings which are executed in the horizontal period, if the processings are not completed within the horizontal period, the system will fail. As for the processings which are executed at the horizontal period, since a time-dependent allowance is smaller as compared with that for the processings which are executed at the vertical period, a degree of freedom of timing when the processing is executed is small. The processing at the horizontal period is called “real time processing” hereinbelow.

As mentioned above, as for the real time processing, a restriction regarding a processing time is severe. Therefore, in the case where the master of the real time processing and the master of the nonreal time processing execute the processings by using the shared memory, in order to prevent the system failure, it is necessary to set the priority of the real time processing regarding the memory access to a high value. However, among the nonreal time processings, there is a case where a plurality of processings of different access restrictions are executed by the same bus master. For example, as processings which are executed by the CPU, there are: a mode setting processing of an image size, a photographing period, and the like at the time of photographing; and an evaluation value processing for evaluating a photographed image and feeding back an evaluation value to control of an iris and a focus lens.

In the mode setting processing, it is necessary that within a current photographing period, a setting for a next photographing period is completed. Therefore, the processings each having a small amount may be executed in a long period or the processing of a large amount may be executed in a short period so long as the processing time falls within the period. Thus, the processing in which a priority of the memory access for the mode setting processing is low is executed. On the other hand, a result of the evaluation value processing is used for control of a focus adjustment or the like. For this purpose, it is required that a priority of the memory access for the evaluation value processing is raised and the processing is executed in a short period.

On the other hand, since the priorities are set on a bus master unit basis, if the fixed priority of the memory access by the CPU is set to a high value in order to execute the evaluation value processing, the memory access for the mode setting processing to be inherently executed at a low priority is also preferentially executed. Thus, such an operation that the fixed priority of the memory access request by another bus master is raised in order to guarantee the real time processing cannot be performed. In the round robin method, if the access request is accepted, the priority decreases. Consequently, there is such a problem that in the case where the user wants to continuously access at a short period, the round robin method does not effectively act.

To solve such a problem, the Official Gazette of Japanese Patent Application Laid-Open No. 2012-103763 proposes a method whereby an upper limit value of an access amount is set on a bus master unit basis and a band limiting for limiting a usage frequency of a bus is performed. By using such a method, the processing can be executed in a state where the priority is set to a high value in a range in which the real time processing will not fail.

However, according to the band limiting method, when the access amount exceeds a limit value, the priority is suppressed to a low value irrespective of the processing contents of the bus master. Therefore, when the band limiting is applied to the bus master which executes a plurality of processings of different priorities, such a situation that the processing cannot be executed at the expected priority can occur in dependence on the processing order. For example, in the case where the processing whose priority may be low is preferentially executed and the band limiting is applied, even if the processing of the high priority occurs after the band limiting, it will be executed only at the low priority. As mentioned above, the memory access control in the imaging processing so far has such a problem that user's desired control cannot be made in dependence on the order of a plurality of processings.

### SUMMARY OF THE INVENTION

To solve the foregoing problems, according to an aspect of the invention, a data processing apparatus comprises: a generation unit configured to generate a sync signal related to a frame period of moving image data; a plurality of processing units each configured to execute a processing in accordance with the sync signal; a memory; and a memory control unit configured to accept access requests to the memory from the plurality of processing units and control a data transfer between each of the plurality of processing units and the memory in accordance with the access request, wherein the memory control unit sets a first period to mask the access request from a predetermined processing unit among the plurality of processing units in accordance with the sync signal and does not accept the access request from the predetermined processing unit in the first period.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a constructional diagram of an imaging apparatus to which memory control of the first embodiment of the invention is applied.

FIGS. 2A and 2B are diagrams for describing the memory control operation according to the first embodiment of the invention.

FIG. 3 is a constructional diagram of an imaging apparatus to which memory control of the second embodiment of the invention is applied.

FIGS. 4A and 4B are diagrams for describing the memory control operation for making clock control according to the second embodiment of the invention.

FIG. 5 is a constructional diagram of an imaging apparatus to which memory control of the third embodiment of the invention is applied.

FIGS. 6A and 6B are diagrams for describing the memory control operation which is executed in consideration of refresh control according to the third embodiment of the invention.

### DESCRIPTION OF THE EMBODIMENTS

Various exemplary embodiments, features, and aspects of the present invention will be described in detail below with reference to the drawings.

The embodiments illustrate examples of a construction as a data processing apparatus in the case where the invention is applied to an image processing unit of an imaging apparatus such as a digital camera or the like. However, the invention is not limited to such examples but may be applied to an apparatus such as PC, portable phone, smart phone, or the like having the construction of an image data processing in a manner similar to the embodiments or to another data processing apparatus having a memory control structure in order to process data.

### First Embodiment

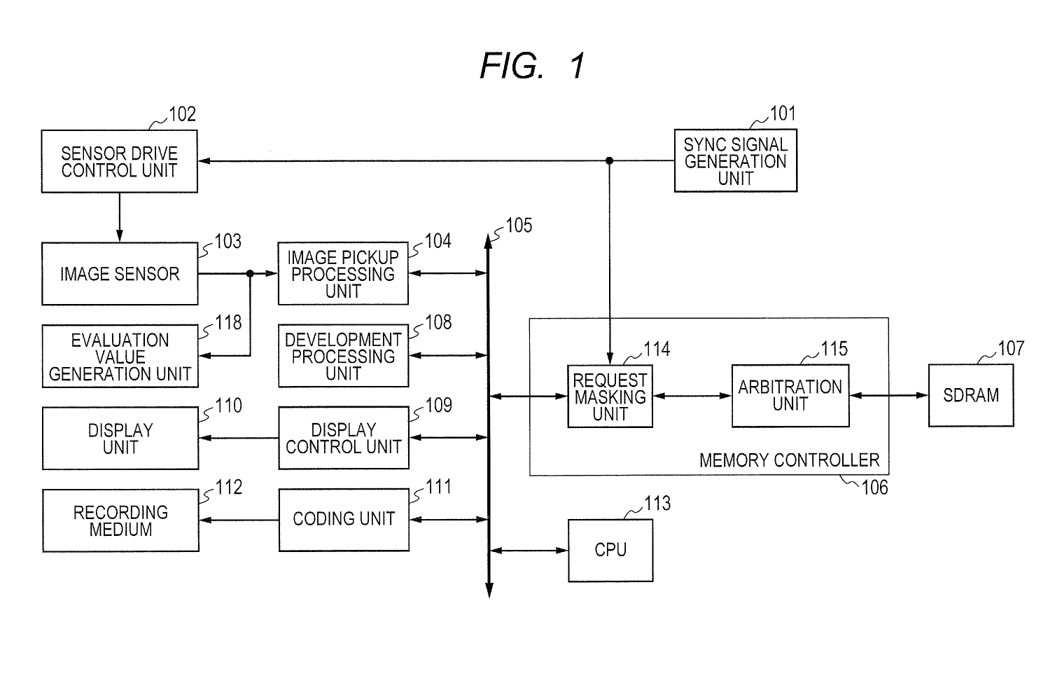

FIG. 1 is a diagram illustrating a construction of an imaging apparatus to which memory control according to the first embodiment of the invention is applied. In the diagram, an imaging processing is realized by component elements 104, 108, 109, 101, 111, 106, and 107 under control by a CPU 113 of the imaging apparatus. Processing units 104, 108, 109, 111, and 113 correspond to bus masters. Those processing units are connected to a memory through a memory bus and output access requests to the memory in accordance with a processing specification.

In FIG. 1, a sync signal generation unit (timing generator) 101 generates a horizontal sync signal and a vertical sync signal in accordance with an operation mode upon photographing and outputs to a sensor drive control unit 102. The sync signal generation unit 101 also generates a sync signal for a display processing of a display unit 110 in accordance with an output specification to the display unit 110 such as image data or the like and outputs to a display control unit 109. In the present embodiment, since the sync signal of the display output is not used in the memory control, only the horizontal sync signal and the vertical sync signal are illustrated. The sensor drive control unit 102 generates control pulses for controlling a charge accumulation and a data output of an image sensor 103 on the basis of the sync signals and outputs to the image sensor 103. In the image sensor 103, an object image formed by a photographing optical system (not shown) is photoelectrically converted by an imaging element, thereby generating image data (still image or moving image data).

An image pickup processing unit 104 is a real time image processing unit for properly performing a defect pixel correction, a shading correction, and the like to the moving image data which is output from the image sensor 103. The image data processed by the image pickup processing unit 104 is stored into an SDRAM 107 through a memory bus 105 and a memory controller 106. An evaluation value generation unit 118 analyzes a spatial frequency in an evaluation area which is preset in each picture plane of the moving image data which is input from the image sensor 103 and generates an evaluation value. Information of the evaluation value generated by the evaluation value generation unit 118 is sent to the CPU 113 and processed.

A development processing unit 108 reads out the image data after the image pickup processing from the SDRAM 107 through the memory bus 105 and the memory controller 106, executes a development processing, and stores the image subjected to the processing into the SDRAM 107 through the memory bus 105 and the memory controller 106. The development processing includes processings such as: pixel interpolation; filtering processing; resizing processing such as a reduction; color conversion processing; processing for converting the image data into, for example, a format of (Y, Cb, Cr) as a format suitable to store as compressed image data; and the like.

The display control unit 109 reads out the image data after the image pickup processing from the SDRAM 107 through the memory bus 105 and the memory controller 106 and outputs to the display unit 110. A coding unit 111 reads out the moving image data after the development processing from the SDRAM 107 through the memory bus 105 and the memory controller 106, executes a compression & coding processing of H.264 or the like, and records coded data into a recording medium 112. The CPU 113 executes a control program stored in a memory (not shown), controls the whole imaging apparatus, and controls settings of each processing unit in accordance with the photographing operation.

Subsequently, an internal construction of the memory controller 106 will be described. On the basis of the sync signals from the sync signal generation unit 101, a request masking unit 114 generates a request masking signal which is preset into each bus master and masks the access requests from the bus masters (104, 108, 109 and 111). The access request (read request, write request) to the SDRAM 107, a command, and data are output from each bus master. When the access requests are simultaneously accepted from the plurality of bus masters, an arbitration unit 115 selects the access request from one bus master in accordance with an access condition (for example, priority) which is preset in accordance with a processing specification, and controls a data transfer to the SDRAM 107.

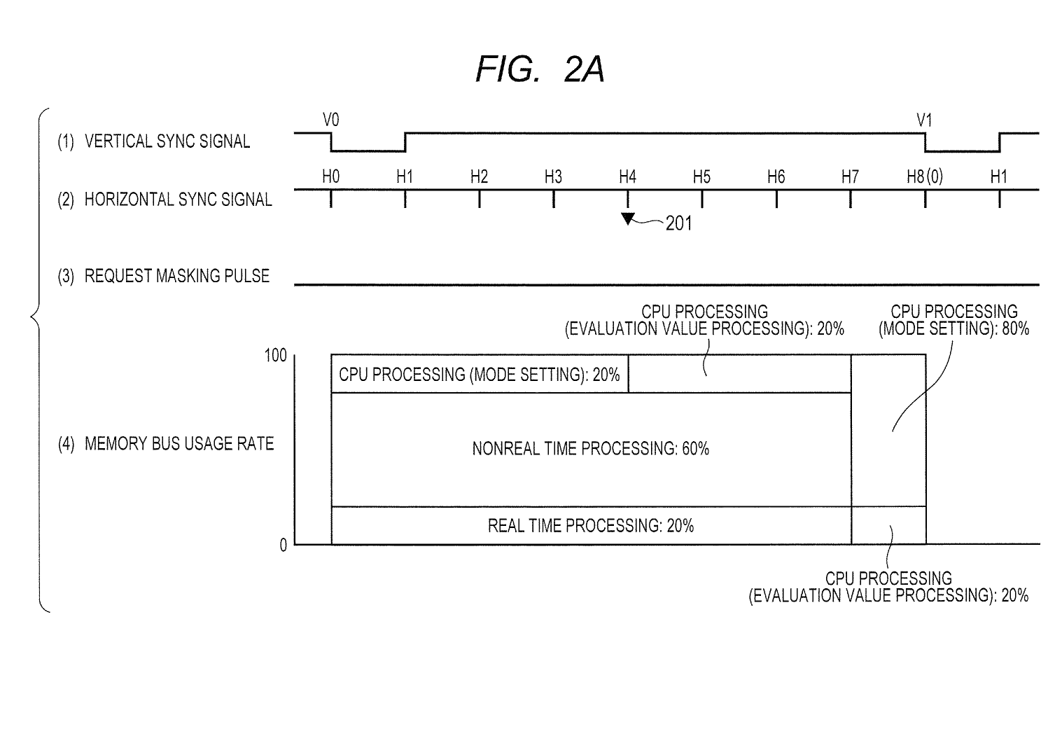

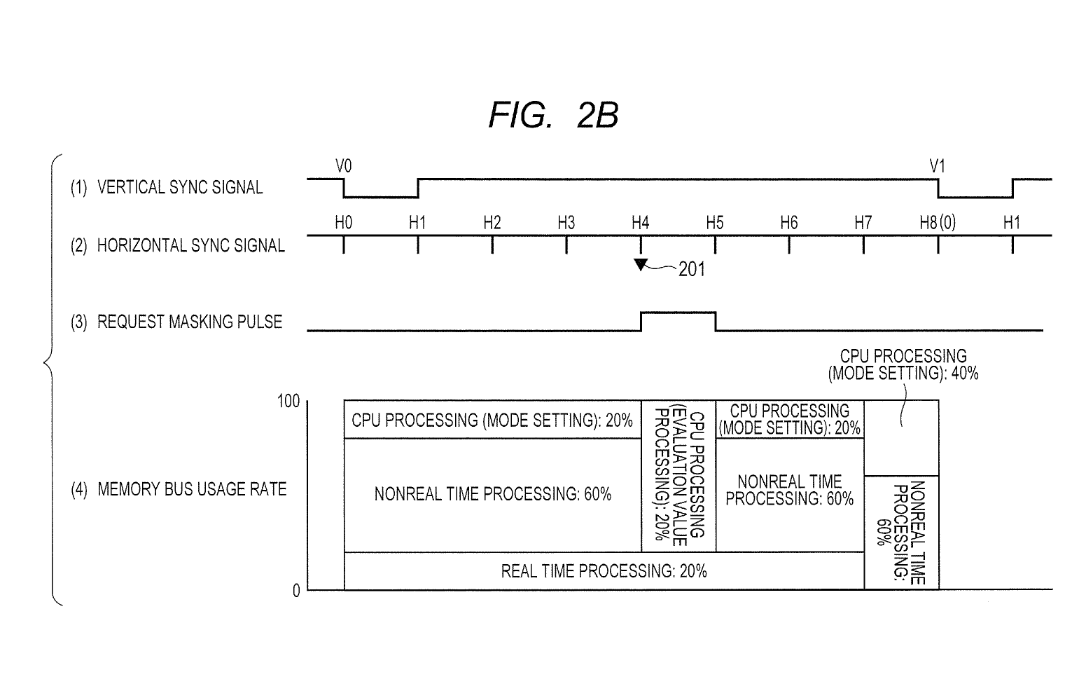

FIGS. 2A and 2B are diagrams for describing the request masking control which is made by the memory controller 106. In FIGS. 2A and 2B, (1) denotes a vertical sync signal and indicates a read-out period of the moving image data from the image sensor. In FIGS. 2A and 2B, a period of V0 to V1 is a period of one picture plane (one frame) in the image data of a plurality of picture planes which are processed in the imaging apparatus. (2) denotes a horizontal sync signal and indicates a read-out period of a line unit from the image sensor 103. In the present embodiment, in order to simplify a description, it is assumed that the image data is constructed by 8 lines corresponding to H0 to H7. A mark 201 (▾) in (2) indicates timing when the evaluation value is generated by the evaluation value generation unit 118. (3) indicates ON/OFF of the request masking control. (4) indicates a usage rate of the memory bus 105 by each processing unit. In (4), it is assumed that a processing in a horizontal sync signal period is a real time processing, a processing in a vertical sync signal period is a nonreal time processing, and a processing of the CPU 113 is a CPU processing, and a memory bus usage rate in the horizontal sync signal period is shown. It is now assumed that fixed priorities as an access condition set by the arbitration unit 115 are set in order of real time processing>nonreal time processing>CPU processing, and the memory bus is used in order from the processing of the higher priority. The CPU processing includes two kinds of processings of a mode setting processing and an evaluation value processing and the evaluation value processing is preferentially executed.

Although the access request to the memory which is output from each processing circuit is not illustrated in FIGS. 2A and 2B, each processing circuit outputs the access request to the memory controller 106 in accordance with each processing timing. The memory access requests of a plurality of number of times are output in accordance with necessity. The memory bus usage rate is a time-dependent rate of a time during which the memory bus 105 is used for the memory access to each processing circuit. The memory controller 106 controls the acceptance of the memory access request in accordance with the priority of each processing circuit so as to obtain the bus usage rate illustrated in FIGS. 2A and 2B.

A request masking method of the present embodiment will be described with reference to FIGS. 1, 2A, and 2B. First, a processing specification of each processing unit in the present embodiment will be described. Since it is necessary to execute the processing of the image pickup processing unit 104 in accordance with the display period of the horizontal sync signal, it is the real time processing. Since it is also necessary to execute the processing of the display control unit 109 in accordance with the period of the display unit 110, it is the real time processing. In (4) in FIGS. 2A and 2B, for simplicity of explanation, it is assumed that the processing period of the image pickup processing unit 104 and the processing period of the display control unit 109 are equalized and the processings of those units are generally called “real time processing”.

As for the development processing unit 108 and the coding unit 111, since it is sufficient that the image data can be read out from the SDRAM 107 and processed within the vertical period shown by the vertical sync signal in (1), the processings of those units are a nonreal time processing. In this instance, for simplicity of explanation, the processings of the development processing unit 108 and the coding unit 111 are generally called “nonreal time processing”.

When each processing unit is executing a processing to be executed in the current vertical period, the CPU 113 executes a mode setting to make various kinds of settings for the processing in the next vertical period. The CPU 113 executes an evaluation value processing for analyzing the evaluation value which is generated at the timing shown by mark 201 (▾) in (2) and feeding back to the control of an iris and a focus lens. Although the processing of the CPU 113 is the nonreal time processing, since a speed of the evaluation value processing exerts an influence on performance such as a focus speed or the like, it is required that the evaluation value processing is executed at a speed as high as possible so long as other processings will not fail.

Subsequently, the request masking control and its effect will be described. FIG. 2A illustrates the memory access control in the case where the request masking control is not performed. In this case, since the priority of the CPU processing is lowest, the CPU processing is executed at timing when the accesses of the real time processing and the nonreal time processing are blanking. Therefore, even if the evaluation value processing is started in accordance with the timing when the evaluation value is generated as shown by mark 201 (▾) in (2), it becomes a processing which can be executed for a period during which other processings are blanking and becomes a processing which is executed in the horizontal sync signal period of 4 H within a range of H4 to H8. FIG. 2B illustrates the memory access control in the case where the request masking control is performed. In a feedback processing using the evaluation value, since the evaluation values among a plurality of (frames) continuous images are compared for a preset evaluation area, the timing when the evaluation value is generated is predetermined. Therefore, the request masking signal is generated in a period from H4 to H5 according to the timing when the evaluation value is generated as shown by mark 201 (▾) in (2). By masking the access request of the nonreal time processing by the request masking signal, after the real time processing, the evaluation value processing can be executed in the period from H4 to H5. Thus, the evaluation value processing can be preferentially executed than the nonreal time processing in the limited period from H4 to H5 without exerting an influence on the real time processing.

As described above, according to the first embodiment of the invention, when the processings of the different access requests are executed from the single bus master, the access request of a specific bus master is masked in accordance with the timing when a specific processing occurs. Consequently, the processing of the bus master of the low fixed priority can be preferentially executed without causing the real time processing to fail.

### Second Embodiment

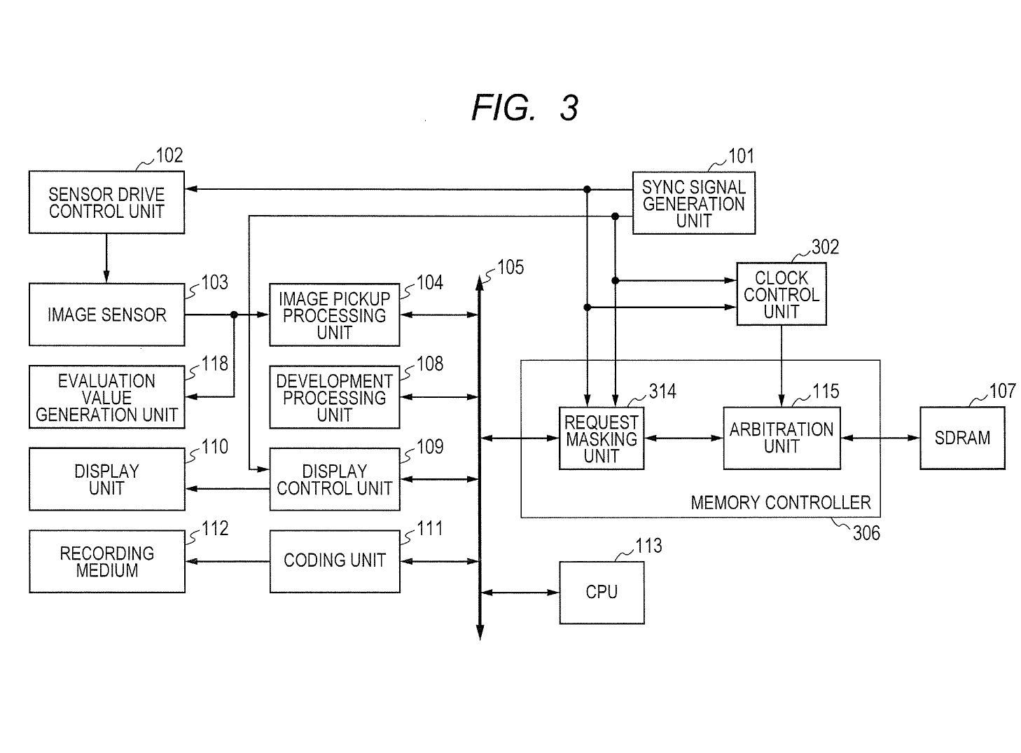

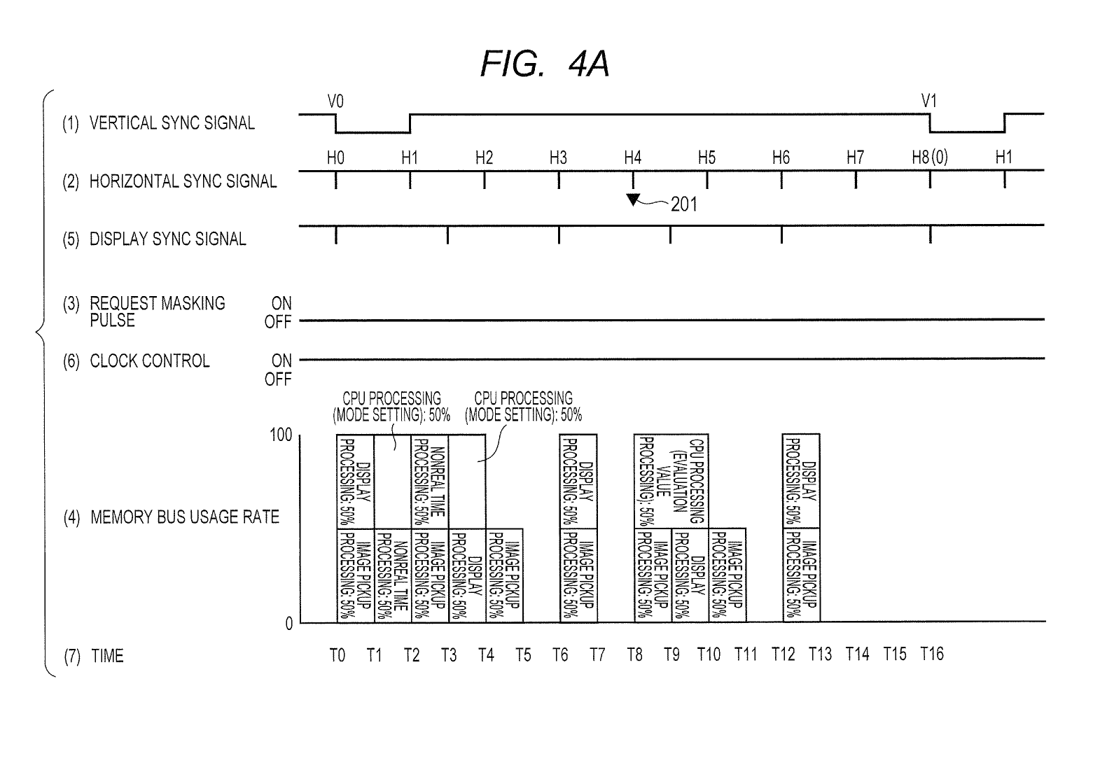

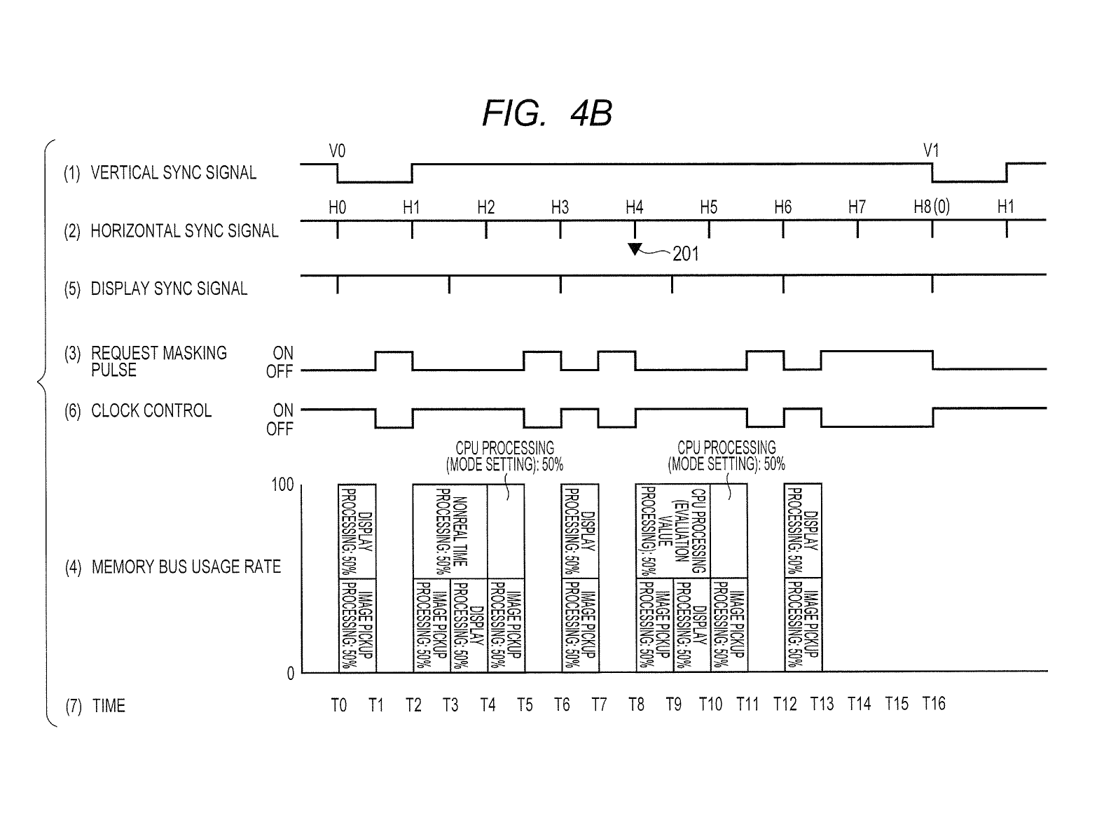

Subsequently, the second embodiment will be described with reference to FIGS. 3, 4A and 4B. The embodiment provides such a memory control structure that when the access request from the bus master is masked, electric power consumption can be reduced by also stopping clocks in the masking period.

In the imaging apparatus, a use situation of the memory bus changes largely in dependence on a situation upon photographing. In a preview state in which an angle of view is confirmed before the recording of a moving image or a still image is executed, since the recording processing or the like of an image is not executed, the usage rate of the memory bus is low. At the time of preview, since electric power consumption of a battery is suppressed, power saving control is made. For example, in the case where the image is not recorded, clocks of the coding unit and the like which are unnecessary are stopped. However, since the timing when the access request is generated from the bus master is unknown, the clocks to the memory bus cannot be stopped. There is, consequently, such a problem that even if the usage rate of the memory bus is low, the electric power consumption cannot be reduced. The present embodiment provides a memory control construction to solve such a problem. Specifically speaking, when the usage rate of the memory bus is low, the access request from the bus master is masked so long as the access restriction of each processing will not fail, and the clocks for the memory control in the masking period are stopped. Owing to this construction, the electric power consumption of the image processing apparatus can be reduced.

FIG. 3 is a diagram illustrating a construction of the imaging apparatus according to the present embodiment. In the diagram, substantially the same component elements as those in FIG. 1 illustrating the first embodiment are designated by the same reference numerals and their description is omitted here. A description of substantially the same operation as that in the first embodiment is also omitted here.

In FIG. 3, in a manner similar to the first embodiment, the sync signal generation unit 101 generates the horizontal sync signal and the vertical sync signal in accordance with an operation mode of the imaging apparatus and outputs to the sensor drive control unit 102. The sync signal generation unit 101 generates the sync signal of the display unit 110 in accordance with an output specification to display unit 110 such as image data or the like and outputs to the display control unit 109. In a memory controller 306, a request masking unit 314 uses the two kinds of sync signals from the sync signal generation unit 101 as triggers, generates a request masking signal which is preset into each bus master, and masks the access request from the bus master. The memory bus 105 executes a data transfer processing in accordance with clocks from a clock control unit 302. The clock control unit 302 uses the sync signals from the sync signal generation unit 101 as triggers and stops the supply of the clocks to the memory bus 105 and the arbitration unit 115 for a period of time during which no access request is generated since the access request is masked in the request masking unit 314.

Subsequently, clock control according to the request masking control in the present embodiment and its effect will be described. FIGS. 4A and 4B are diagrams for describing the clock control according to the request masking control in the present embodiment. In the diagrams, substantially the same component elements as those in FIGS. 2A and 2B illustrating the first embodiment are designated by the same reference numerals and their description is omitted here.

In FIGS. 4A and 4B, (5) indicates a display sync signal showing an operation period of the display control unit. In a case where an image size which is read out of the image sensor 103 and an image size which is displayed to the display unit 110 differ, the display control unit 109 operates at a period different from that of the horizontal sync signal. (6) indicates clock control of the memory controller 306. For a period of time during which the output of the clocks is stopped, the operation of the arbitration unit 115 is stopped and the data transfer to the SDRAM 107 is stopped, thereby suppressing the electric power consumption. (7) indicates time for describing timing in the vertical period.

FIG. 4A is a diagram illustrating the memory control operation in the case where the clock control is not performed. Since the horizontal sync signal and the display sync signal are synchronized at time T0, T6, and T12, the image pickup processing and the display processing which are the real time processing are executed. The image pickup processing is executed at time T2, T4, T8, and T10 synchronously with the horizontal sync signal. The display processing is executed at time T3 and T9 synchronously with the display sync signal.

Since the image pickup processing and the display processing are periodically executed, even in a case where the whole memory bus usage rate is low, they cannot be early executed. On the other hand, the nonreal time processing and a mode processing are early executed in a period during which the memory bus is not in use. In FIG. 4A, the nonreal time processing and the mode processing within the vertical period are completed at time from T1 to T4 and those processings do not occur after T4.

With respect to the evaluation value processing, in FIGS. 4A and 4B, the processing to generate the evaluation value at the timing shown by mark 201 (▾) in (2) is started and the processing is completed at time from T8 to T10. In such a state, if a memory bus usage amount is small, there is a case where a period during which no accesses occur as shown at T5, T7, T11, and T13 to T16 in dependence on a photographing condition. However, since the memory controller is in a standby mode in which the access can be always accepted, the electric power is consumed in vain.

FIG. 4B is a diagram illustrating the memory control operation in the case where the clock control in the present embodiment is performed. In the present embodiment, the processing timing is preliminarily scheduled so long as the access restriction of each processing is preliminarily satisfied under the photographing condition, and the request masking is controlled in accordance with a result of the scheduling, thereby controlling the period during which the access to the SDRAM 107 occurs. Specifically speaking, as illustrated in FIG. 4B, since the sync signals which become the triggers of the image pickup processing and the display processing are not generated at T1, the memory access at T1 in which the real time processing is unnecessary is masked, and a processing in the masking period occurs only at the display sync signal serving as a trigger of the display processing. The memory access is adjusted in such a manner that the masked mode setting processing and the nonreal time processing are executed at the timing T4 and T10 in which although the real time processing is necessary, the usage rate of the memory bus 105 is low, and the output of the clocks in the period during which the access to the SDRAM 107 does not occur is stopped. Thus, the period during which the access to the memory bus 105 does not occur can be extended and the electric power consumption can be reduced as compared with that in the memory control in FIG. 4A.

The request masking unit 314 outputs information showing a period during which the request from each bus master is masked to the clock control unit 302. In the masking period, the clock control unit 302 stops the supply of the clocks to the arbitration unit 115 and the memory bus 105.

As described above, according to the present embodiment, the period for also masking the access to the SDRAM from any master is set so long as the masking control is in contravention of the access restriction of each processing and the output of the clocks to the memory bus 105 is stopped in the masking period, so that the electric power consumption can be reduced.

### Third Embodiment

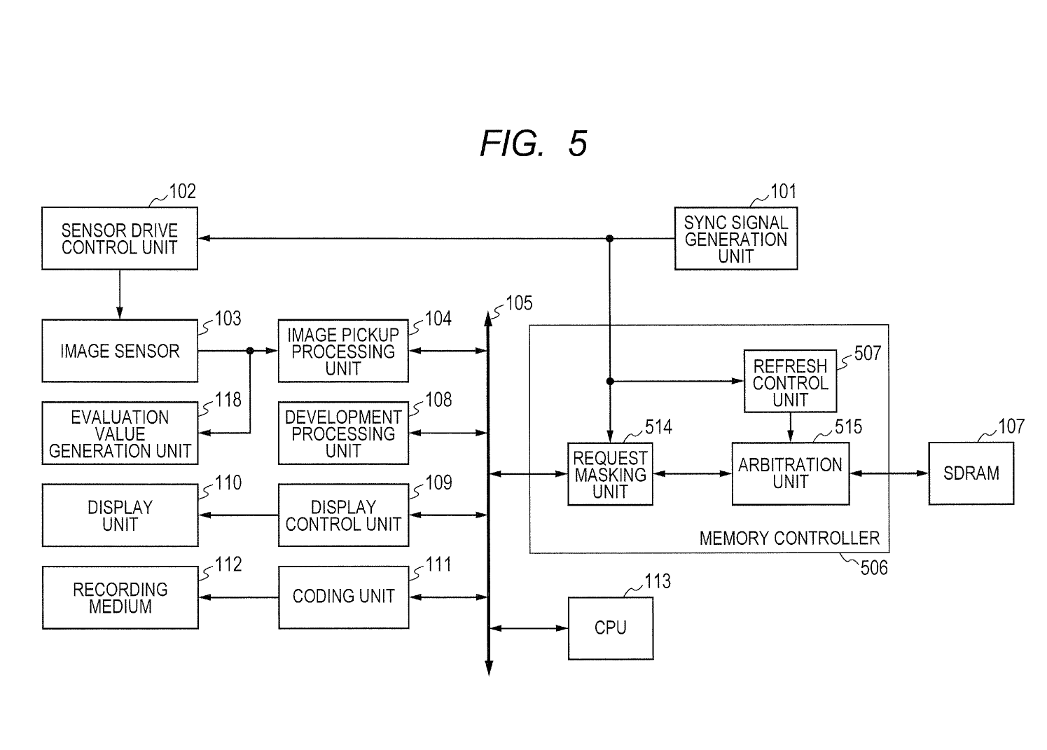

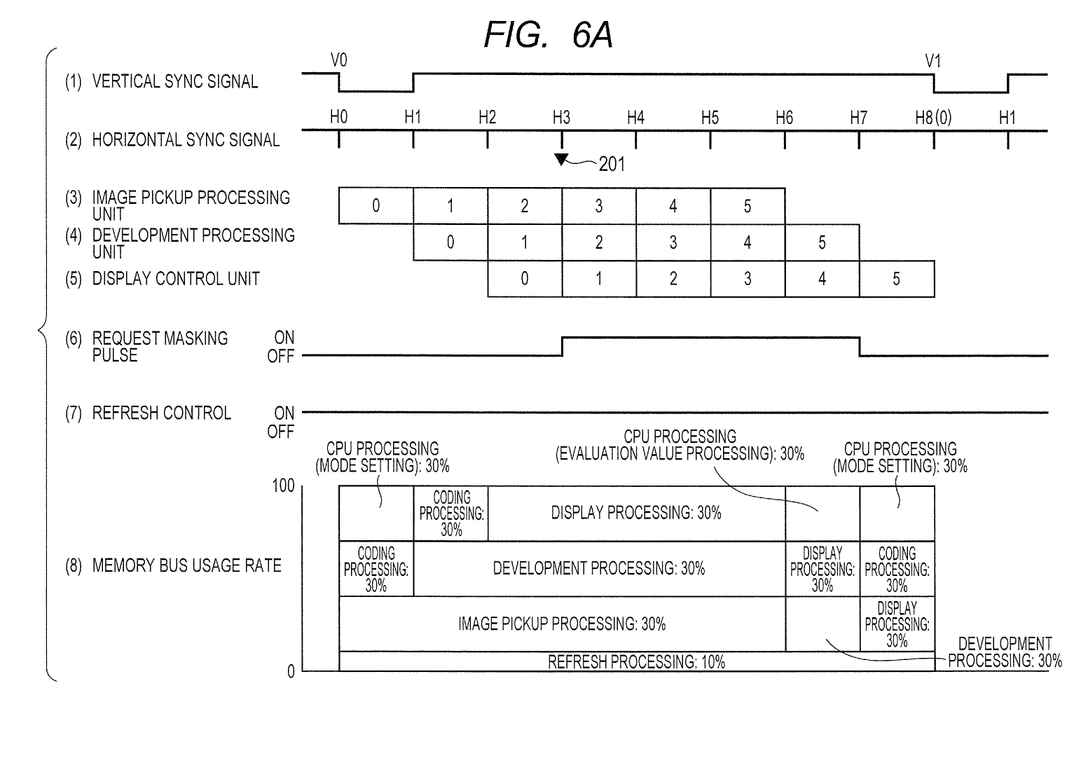

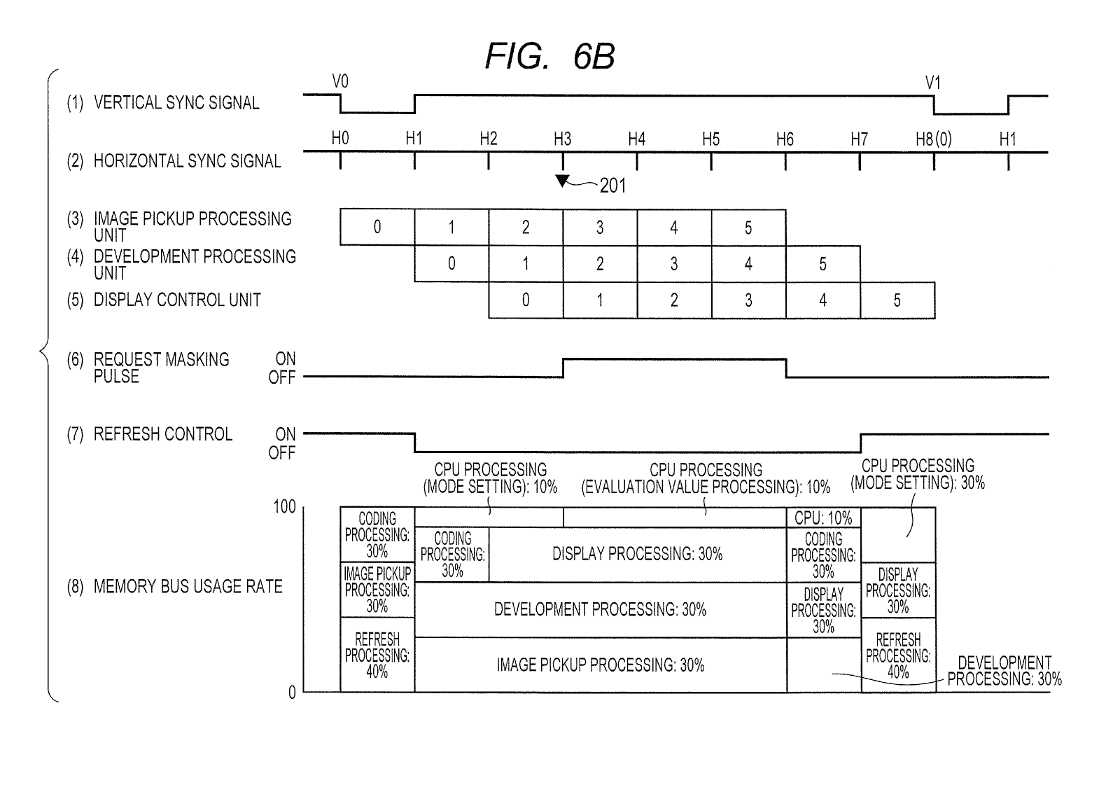

Subsequently, the third embodiment of the invention will be described with reference to FIGS. 5, 6A and 6B. The present embodiment provides a memory control construction in consideration of a refresh processing of the SDRAM.

As for a volatile memory such as an SDRAM or the like, if the refresh processing is not executed within a predetermined period, data vanish. Therefore, an access for an imaging processing and an access for the refresh processing exist mixedly in a memory bus at the time of the actual photographing, and a refresh control unit is considered as a kind of bus master. If the data vanish, the system will fail. Therefore, a priority of the refresh processing is set to a high value. However, the access restriction of the bus master for the imaging processing fluctuates in dependence on a situation at the time of the photographing. On the other hand, since a restriction of the refresh processing is determined by a device specification of the volatile memory, it does not fluctuate fundamentally. Therefore, even if there is a margin in other timing due to the access restriction, the refresh processing is preferentially executed and there is such a problem that the imaging processing to be executed at a speed as high as possible such as an evaluation value processing or the like cannot be executed at a high speed. To solve such a problem, the present embodiment provides a construction in which the occurrence of the refresh processing is controlled in accordance with whether an amount of accesses of the imaging processing which occur within the photographing period of one image frame is large or not, thereby enabling such a situation that the access of another bus master is unnecessarily restricted to be prevented.

FIG. 5 is a diagram illustrating a construction of an imaging apparatus according to the third embodiment. In the diagrams, substantially the same component elements as those in FIG. 1 illustrating the first embodiment are designated by the same reference numerals and their description is omitted here. A description of substantially the same operation as that in the first embodiment is also omitted here.

In a memory controller 506 in FIG. 5, a request masking unit 514 uses the sync signals from the sync signal generation unit 101 as triggers and generates a mask pattern so that a period during which the access request from the bus master for the imaging processing does not occur can be provided. A refresh control unit 507 uses the sync signals from the sync signal generation unit 101 as triggers and controls so that the refresh request occurs in a period during which the access request for the imaging processing is masked.

FIGS. 6A and 6B are diagrams for describing the memory control which is made in consideration of the refresh control of the present embodiment. In the diagrams, (1) denotes a vertical sync signal and indicates a read-out period of the image data of one picture plane from the image sensor 103. In FIGS. 6A and 6B, a period from V0 to V1 is a vertical period of one image frame. (2) denotes a horizontal sync signal and indicates a read-out period of the image data of one horizontal line from the image sensor 103. In FIGS. 6A and 6B, it is assumed that a period from H0 to H6 denotes an effective image period and a period from H6 to H8 indicates a blanking period. (3) indicates operation timing of the image pickup processing unit 104. A period of the image data which is read out of the image sensor 103 and is being processed is shown by a numeral (corresponding to H0 to H6). (4) and (5) indicate operation timing of the development processing unit 108 and the display control unit 109 in a manner similar to (3). In the present embodiment, the image pickup processing unit 104, the development processing unit 108, and the display control unit 109 are pipeline-processed, thereby reducing a display delay to the display unit 110. Therefore, as for the processings of (3) to (5), the priority is set as a bus master of the real time processing. (6) indicates ON/OFF of the request masking control. (7) indicates ON/OFF of the refresh control. (8) indicates a usage rate of the memory bus per processing.

Subsequently, the refresh control according to the request masking control in the present embodiment and its effect will be described. FIG. 6A illustrates the memory control operation in the case where a refresh request is performed at a fixed period. It is now assumed that the fixed period for refresh is a horizontal sync signal period for the purpose of simplicity of description. If the refresh control is in contravention of the refresh restriction, the data vanish. Therefore, the priorities of the processings are set as follows: that is, refresh processing>image pickup processing>development processing>display processing>coding processing>CPU processing. In FIG. 6A, in a period of H2 to H6, the bus masters of the refresh processing and the real time processing occupy the memory bus. Therefore, even if the request masking is controlled at the timing when the evaluation value is generated at mark 201 (▾) in (2) and the access request from the bus master of the nonreal time processing is masked, the evaluation value processing cannot be preferentially executed.

FIG. 6B illustrates the memory control operation in the case where the timing for performing the refresh request is controlled in accordance with the present embodiment. In FIG. 6B, in a period from H0 to H1 and a period from H7 to H8, a rate at which the bus master of the real time processing is operating is low. Therefore, in FIG. 6B, the access request is adjusted in such a manner that the refresh control in a period from H2 to H6 is turned off, the refresh processing is concentrated on the period from H0 to H1 and the period from H7 to H8, and the CPU processing is executed in a period from H1 to H6 which is provided as a blanking period by the refresh control. Assuming that V0 to V1 is a period of the refresh control, in FIGS. 6A and 6B, the numbers of times of the refresh processing are equal. The request masking unit 514 generates a mask pattern in accordance with the adjustment of the access request, thereby enabling the evaluation value processing to be rapidly completed at the timing when the evaluation value is generated.

As described above, according to the present embodiments, in the range where the restriction of the refresh processing is satisfied, by concentrating the refresh processing on the timing when the number of accesses from other bus masters is small, such a situation that the accesses from other bus masters are unnecessarily restricted can be prevented.

According to the foregoing embodiments of the invention, by masking the access request to the memory in accordance with the access conditions of a plurality of bus masters and scheduling the memory accesses, the complicated memory bus arbitration is realized, a processing speed can be improved, and the electric power consumption can be reduced.

In the foregoing embodiments, the data processing apparatus having the memory control construction of the invention has been described with respect to the image data processing unit of the imaging apparatus as an example. The invention is not limited to the processing of the image data. Naturally, the invention can be also applied to another data processing apparatus including the control construction of the memory accesses.

### Other Embodiments

Embodiments of the present invention can also be realized by a computer of a system or apparatus that reads out and executes computer-executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer-executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention is described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-178320, filed on Aug. 29, 2013, which is hereby incorporated by reference herein in its entirety.

What is claimed is:

1. A data processing apparatus comprising:
a generation unit configured to generate a sync signal related to a frame period of moving image data;
a plurality of processing units each configured to execute a processing in accordance with the sync signal;
a memory; and
a memory control unit configured to accept access requests to the memory from the plurality of processing units and control a data transfer between each of the plurality of processing units and the memory in accordance with the access request,
wherein the memory control unit sets a first period to mask the access request from a predetermined processing unit among the plurality of processing units in accordance with the sync signal and does not accept the access request from the predetermined processing unit in the first period.

2. An apparatus according to claim 1, wherein:
the plurality of processing units include a real time processing unit and a nonreal time processing unit; and
the predetermined processing unit is the nonreal time processing unit.

3. An apparatus according to claim 1, further comprising a central processing unit (CPU), and
wherein the memory control unit accepts the access request from the CPU in the first period.

4. An apparatus according to claim 1, wherein the memory control unit arbitrates the access requests from the plurality of processing units in a period other than the first period in accordance with a predetermined condition set in the plurality of processing units.

5. An apparatus according to claim 4, wherein the memory control unit arbitrates the access requests from the plurality of processing units in a period other than the first period in accordance with priorities set in the plurality of processing units.

6. An apparatus according to claim 1, wherein the first period is a partial period in the frame period.

7. An apparatus according to claim 1, wherein the plurality of processing units access the memory through a bus which operates in accordance with clocks, and wherein the memory control unit sets a second period to mask the access requests from all of the plurality of processing units in accordance with the sync signal and controls such that a supply of the clocks to the bus is stopped in the second period.

8. An apparatus according to claim 1, wherein the memory is a volatile memory in which a refresh processing is necessary, and wherein the predetermined processing unit includes a processing unit for executing the refresh processing.

9. A control method of a data processing apparatus having a memory, comprising the steps of:
generating a sync signal related to a frame period of moving image data;
executing a processing by each of a plurality of processing units in accordance with the sync signal; and
accepting access requests to the memory from the plurality of processing units and controlling a data transfer between each of the plurality of processing units and the memory in accordance with the access request,
wherein the accepting and controlling step includes a step of setting a first period to mask the access request from a predetermined processing unit among the plurality of processing units in accordance with the sync signal and does not accept the access request from the predetermined processing unit in the first period.
